(19) United States
(12) Patent Application Publication
(10) Pub. No.: US 2017/0128967 A1
(43) Pub. Date: May 11, 2017

(54) PUMP DISPENSERS

(71) Applicant: Rieke Packaging Systems Limited, Leicester (GB)

(72) Inventors: Brian Robert Law, Leicester (GB); Simon Christopher Knight, Bridgend (GB)

(21) Appl. No.: 15/405,389

(22) Filed: Jan. 13, 2017

Related U.S. Application Data
(63) Continuation of application No. PCT/GB2015/052030, filed on Jul. 14, 2015.

(30) Foreign Application Priority Data
Jul. 14, 2014 (GB) 1412509.0

(51) Int. Cl. B05B 11/00; B65D 50/04; B65D 41/34

(52) U.S. Cl. CPC B05B 11/3047; B05B 11/306; B05B 11/3001; B65D 41/3428; B65D 50/046

(57) ABSTRACT

A pump dispenser has a pump body held down onto the neck of a container by a closure cap, securing by a rotational engagement, typically a screw thread. To supplement security for demanding shipping conditions the cap and neck have a supplementary locking mechanism which engages selectively in the fully screwed-down position of the cap to inhibit its rotational release of the cap. It may have respective hooked lugs of the cap and neck. Inward lugs or catches may be carried on a bottom collar of the cap. The mechanism may be releasable, such as by resilient deformation such as lateral squeezing to disengage a cap lug from a neck lug. Alternatively a barbed retaining collar, engaging beneath a retaining flange on the neck, may connect to the closure such as through frangible links.

### CROSS REFERENCE TO RELATED APPLICATIONS

This application is a continuation of PCT/GB2015/052030 filed Jul. 14, 2015, which claims the benefit of GB 1412509.0 filed Jul. 14, 2014, both of which are hereby incorporated by reference.

### FIELD OF THE INVENTION

This invention relates to pump dispensers.

### BACKGROUND

Pump dispensers, often of the moveable-nozzle type, in which a pump body is mounted in the neck of a container by a closure cap, are well-known. The container, usually a plastic bottle, has a neck with retaining formations, usually a screw thread. Typically the pump dispenser also comprises a pump module comprising a pump body which may define a pump cylinder. The pump body is mounted in or by a closure cap, which is usually a separate component from the pump body and typically has an outward flange dimensioned to bear down and seal against the edge of the container neck. The closure cap fixes (e.g. screws) down onto the neck with the pump body extending down into the container. The pump body defines a pump chamber with a pump inlet generally having an inlet valve. Often a dip tube is provided extending into the container interior to lead product to the inlet.

A plunger component including a pump piston, a discharge channel, an outward valve and a discharge nozzle operates in the body to change the volume of the pump chamber and discharge product from the nozzle through the discharge valve. Usually the nozzle is part of a laterally-extending plunger head. The user presses on top of the plunger head against a pump spring which tends to merge the plunger to the extended/upward position.

Often the pump is a down-locking pump, comprising locking formations which can couple between the plunger and the pump body to hold the plunger in its retracted (down) position, against the spring. This makes it compact for shipping. Locking may be e.g. by a sloping cam or short thread engagement between the plunger stem and the body, either where the stem emerges from the body or recessed inside the body. Having the lock-down formations recessed inside the body enables a closer fit or seal where the stem emerges from the body, because the lock-down formations need not pass through even at full extension of the plunger.

### SUMMARY

A pump dispenser construction is disclosed in conjunction with the present invention. FIGS. 1 to 3 shows an example of a movable-nozzle pump to illustrate pump module features of a preferred dispenser type in which the present proposals are applicable.

A pump has a body 1 with a cylinder defining a pump chamber 9, with an inlet 11 having an inlet valve 112 and connected to a dip tube 6. The body is mounted in a closure cap 5 having internal threads 55 for securing onto the externally-threaded neck of a container, not shown here. The top annular edge of the body cylinder 1 projects up through a central hole of the closure cap 5 and locks (with a snap fit) into a downward annular slot of a securing collar 81 of a body insert component 8 whose inner tubular part projects down inside the cylinder of the body 1. The bottom end 85 of the insert 8 forms a floor which seats the bottom end of the metal pump spring 7 and has a central hole for the stem 21 of a pump plunger 2 to pass through. The interior bottom end of the insert also has lock-down threads 83.

The pump plunger stem 21 has a thinner lower portion carrying a piston 28 which works in the body cylinder 1, and a larger-diameter upper portion carrying outwardly-facing lock-down threads 211 at its bottom end. A discharge channel 24 extends up through the stem 21, through a conventional outlet valve 22 e.g. a ball valve and out to a laterally-directed discharge channel in the nozzle 211a of the head 29 of the plunger 2. The head 29 has an outer shaped shroud 212 to provide user comfort and an attractive appearance. An external retainer ring or over-collar 82, whose upper diameter closely matches the outer diameter of the upper stem 21, clips onto the top of the insert collar 81 to shield the pump interior and wipe the stem. The extended position of the plunger 2 is limited by the engagement of the piston 28 up against the lower end 85 of the insert 8.

For lock-down, especially for shipping or storage, the plunger 21 is fully depressed and turned to screw the stem lock-down threads 211 into the insert lock-down threads 83. The tip of the stem beneath the piston then holds the inlet valve 112 closed (FIG. 3) to prevent leakage through the pump during shipping

The use of a threaded closure cap 5 is conventional, allowing for easy filling and processing and also the possibility of removing the cap e.g. for the user to re-fill the container, which is desirable with some consumer products.

A known pump dispenser construction such as shown in FIGS. 1 to 3 is reliable and does not leak in conventional usage and shipping. Increasingly however there is a demand for dispensers to be shipped in a filled condition by ordinary post and in various packaging types, e.g. when mailing individually-purchased consumer products rather than commercial lots. This puts a high demand on “shippability” features such as lock-down and sealing. Under repeated shock, vibration and inversion the conventional closure cap may tend to work loose on the container so that product will leak.

The present proposals address this issue.

An aspect of our proposals is to provide a modified or improved connection between the cap and the container neck, better able to withstand shocks and vibrations without coming loose. Preferably the connection between the cap and the neck prevents the cap coming undone from the neck unintentionally or when the user does not specifically want it to be undone, e.g. during transport. Preferably, the cap can be easily engaged with the neck, but the connection between the cap and the neck prevents unwanted disengagement.

Aspects of our proposals are set out in the appended claims, which are repeated here by reference.

Thus, the present pump dispenser may have a locking mechanism which inhibits or prevents rotation of the cap relative to the neck about an axis of the plunger. In some examples, the locking mechanism is reversible; i.e. once it has been disengaged, the cap and neck can be locked together again. In some examples, the locking mechanism is not reusable. In some examples, the locking mechanism comprises components formed on the neck and on the cap. In these cases, the components are usually lockably engageable, so that the cap cannot be twisted around the neck without substantial input from the user. The mechanism may comprise flexible components, such as deformable plastics, which may suitably aid the unlocking process. The disengagement of the locking mechanism preferably requires a threshold force, e.g. one or both of a compression or turning force to be overcome before the cap can be freely rotated about the neck. For example, a component of the cap may be flexibly deformable (compressible) towards the interior of the cap i.e. at least partly in a direction transverse to the rotational movement, in order to unlock the cap from the neck. In other examples, forces such as bending or twisting may be suitable.

Other corresponding aspects of the invention include the following.

[1] A pump dispenser comprising a pump for dispensing fluid from a container to which the pump is attached, the pump comprising
a container having a neck,
a pump body mounted in or by a closure cap, the pump body defining a pump chamber and a plunger reciprocable relative to the pump body in a pumping stroke to alter the volume of the pump chamber;
wherein the closure cap and the neck are capable of rotational engagement with each other about an axis of the plunger
the closure cap and the neck comprising a locking mechanism which inhibits or prevents the rotation of the cap relative to the neck, the locking mechanism having a locked condition in which the cap is capable of little or no rotational movement relative to the neck and an unlocked condition in which the cap can be rotated around the neck.

[2] Pump dispenser of [1], wherein a release movement of the locking mechanism from the locked condition to the unlocked condition comprises a relative rotation of the cap about an axis of the plunger.

[3] Pump dispenser of [1] or [2], wherein a release movement of the locking mechanism from the locked condition to the unlocked condition comprises a compressive force applied to the cap toward the cap interior.

[4] Pump dispenser of any one of [1] to [3] wherein the rotational engagement is threaded engagement.

[5] Pump dispenser of any one of [1] to [4] wherein the cap comprises one or more lugs and the neck comprises lugs capable of engagement with the lugs of the cap.

[6] Pump dispenser of [5] wherein the cap comprises a collar and the lugs are formed on an internal surface of the collar.

[7] Pump dispenser of [6], wherein the collar is flexibly deformable such that the lugs are capable of being disengaged from the lugs of the neck lock formation when the collar is deformed.

[8] Pump dispenser of [6] or [7] wherein the collar is pivotally connected to the cap.

[9] Pump dispenser of any one of [6] to [8] wherein the collar is formed in one or two sections.

[10] Pump dispenser of [5] wherein the cap has a first lug formed on an inner surface and which projects towards the cap interior, and the neck has a corresponding projecting second lug capable of engagement with the first lug.

[11] Pump dispenser of [10] wherein the lugs are contoured to allow lockable engagement.

[12] Pump dispenser of any one of [1] to [4] wherein the locking mechanism comprises a breakable connection.

### BRIEF DESCRIPTION OF THE DRAWINGS

Preferred exemplary embodiments of the present invention are now described with reference to the accompanying drawings, in which:

FIGS. 1 to 3 show a pump module of a known pump dispenser, FIGS. 1 and 3 being axial cross-sections in extended and retracted positions of the plunger thereof and FIG. 2 being an external elevation at smaller scale.

FIG. 4 is a perspective view from above of a pump dispenser according to a first exemplary embodiment of the present invention.

FIG. 5 is a fragmentary schematic cross-section through a neck and cap of the first exemplary embodiment at the bottom end and indicating a release action.

FIG. 6 shows the first exemplary embodiment with the cap partly removed from the neck.

FIG. 7 is a perspective view from above of a pump dispenser according to a second exemplary embodiment of the present invention.

FIG. 8 is a fragmentary detail view of the neck and cap of the second exemplary embodiment at the bottom end, indicating a release action.

FIG. 9 shows the second exemplary embodiment with the cap partly removed from the neck.

FIG. 10 is a side view of a pump dispenser according to a third exemplary embodiment of the present invention.

FIG. 11 is an enlarged view of the third exemplary embodiment with part of the cap broken away to show the locking structure.

FIG. 12 is a side view of a pump dispenser according to a fourth exemplary embodiment of the present invention.

FIG. 13 shows the interior of the cap of the fourth exemplary embodiment.

FIG. 14 shows the fourth exemplary embodiment with the cap separated from the neck.

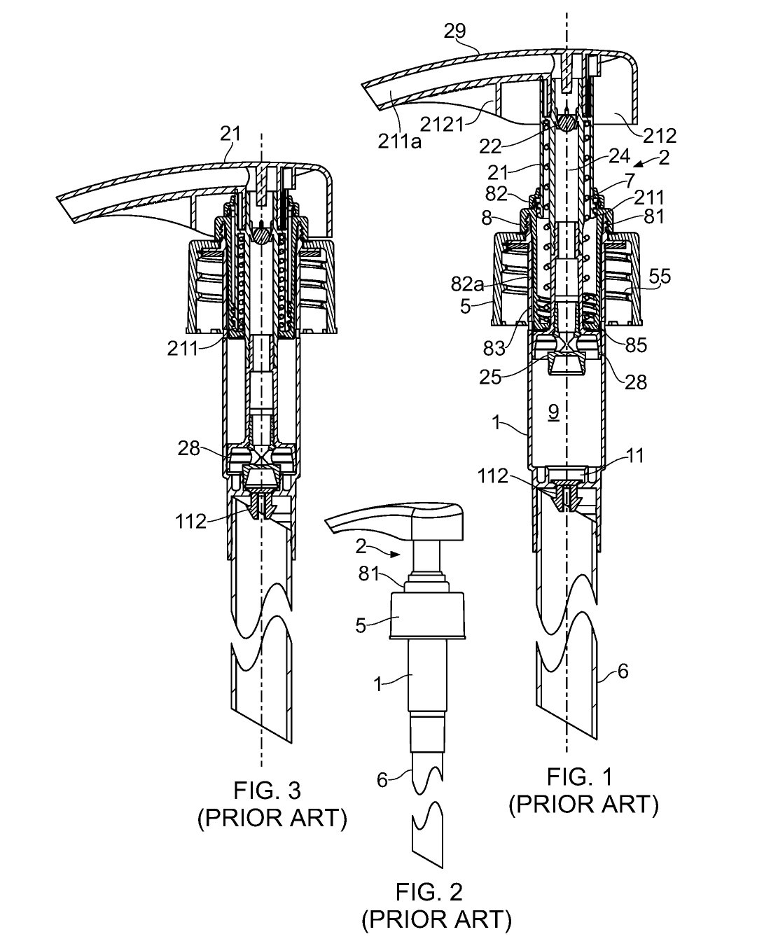

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

In the following description reference numerals for the general components of the dispenser correspond to those used above with reference to the known dispenser, in self-explanatory fashion.

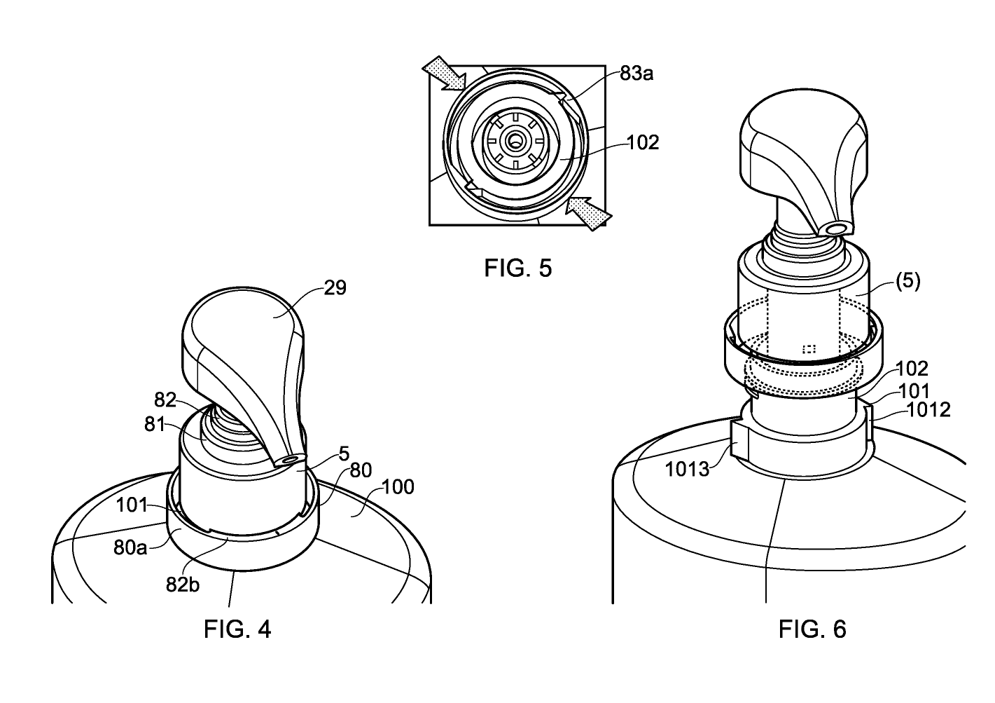

In a first exemplary embodiment of the present invention, shown in FIGS. 4-6, an annular collar 80a is part of the cap 5 and is located around the neck 102. In this example, the collar 80a is wider than the cap 5. The collar 80a is connected to the cap 5 through a connecting portion 82b, and in this example the collar 80a extends all the way around in one piece. There is a gap between the upper surface 80 of the collar 80a and the rest of the cap 5, which accommodates the wider collar width compared to the rest of the cap 5. The gap does not extend all the way around. Of course, examples without such a gap can be used.

FIG. 4 shows the dispenser in a locked position. FIG. 5 is a cross-section through the cap and neck in the locked position. FIG. 6 shows the dispenser in an unlocked and unscrewed position (the pump dispenser is extended), with the cap 5 shown in an elevated position.

The locking mechanism in this example includes the collar 80a of the cap 5 having two lugs or hooks 83a extending inwardly and engageable with lugs or hooks 101 on the outside of the neck 102. The neck lugs or hooks 101 have a steeply sloping or abutment face 1012 which is capable of engaging with the steeply inclined face of the lugs or hooks 83a of the cap in a locked position. The other face of the lugs or hooks 83a,1013 is less steeply sloped. This face constitutes a sliding ramp. Advantageously, this enables the cap 5 to be screwed on to the neck 102 more easily. Other lug/hook shapes may be suitable without departing from the invention. The collar 80a is flexible and capable of being deformed by the user in the direction of the arrows in FIG. 5 (i.e. towards the interior of the cap, which may be approximately perpendicular to the rotation axis of the plunger). This disengages the lugs or hooks 83a,101 and allows the cap 5 to be unscrewed.

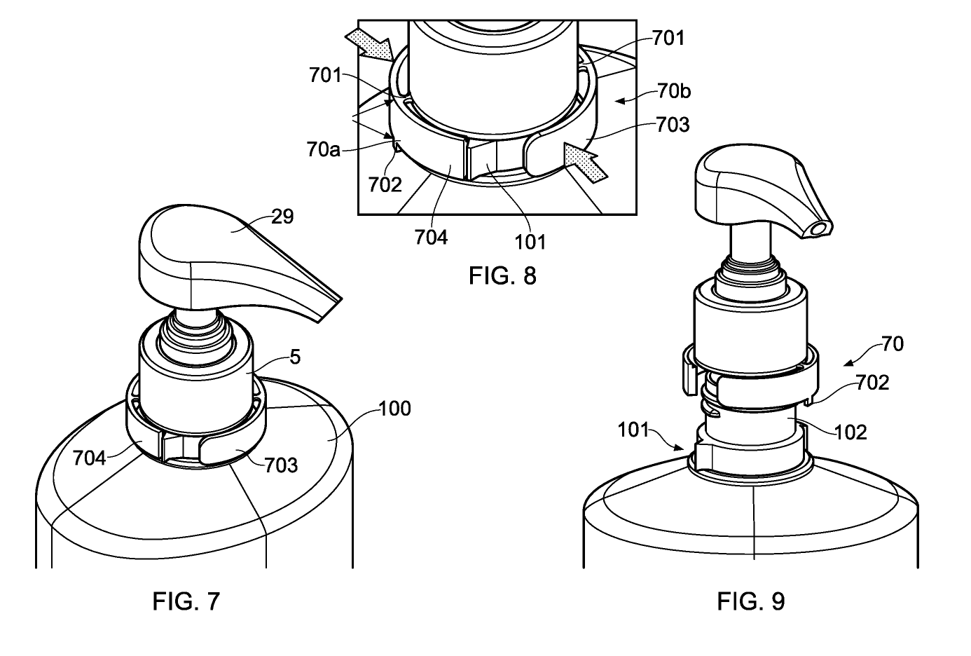

A second exemplary embodiment of the present invention is shown in FIGS. 7-9. FIG. 7 shows the dispenser in a locked position. FIG. 8 is a cross-section through the cap and neck in the locked position. FIG. 9 shows the dispenser in an unlocked and unscrewed position (the pump dispenser is extended), with the cap 5 shown in an elevated position.

In this case, the cap 5 has a collar which is in two pieces 703,704 (the collar pieces are the same on each side; other numbers of pieces may alternatively be suitable). These pieces 703,704 are connected to the rest of the cap 5 by pivots 701 also indicated “P” while downward extending pieces 702 sit the collar on the container 100. Similar to the first example, the neck has two lugs 101 at opposite sides of the neck 102 each with a steeply sloping (abutment) side 1012 and a less steeply sloping (ramp) side 1013. The collar pieces 703,704 in this example are shown with one end which engages (abuts) the steeply sloping face 1013 of the lugs of the neck. The user can unscrew the cap 5 from the neck 102 by compressing the pieces 703,704 at the points shown by arrows in FIG. 8 (i.e. towards the interior of the cap). In this case, the collar pieces 703,704 swing around the bendable pivot point, thereby acting as locking levers and allowing the user to disengage the collar pieces 703,704 from the lugs 101 and thereby allow the cap to be unscrewed. The cap can be screwed on easily. The cap cannot be undone without pressing both the locking levers (collar pieces) at the appropriate ends to release them from the neck abutments 101.

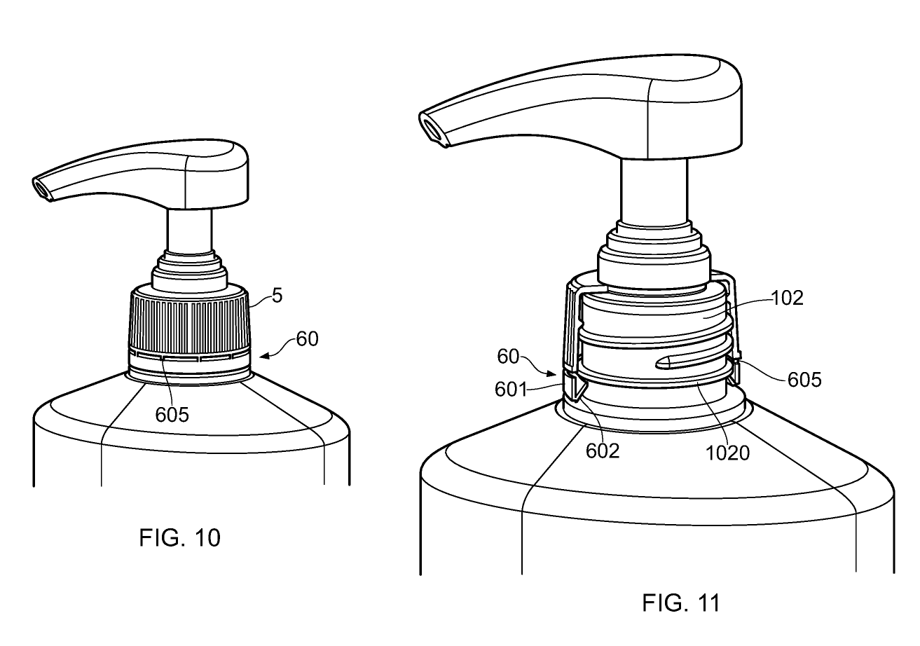

A third exemplary embodiment of the present invention is shown in FIGS. 10 to 11. The cap 5 has a collar or retaining ring 60. In FIG. 11, part of the cap 5 and retaining ring/collar 60 are broken away for illustration. The retaining ring/collar 60 is attached to the rest of the cap 5 by a plurality of breakable or frangible connecting links 605. The retaining ring/collar 60 has an external piece or annulus 601 to which the links 605 are connected, and a sloping inner piece or annulus 602. The cylindrical external annulus 601 connects hingedly to the conical (upwardly convergent) inner annulus 602 around their bottom edges. The sloping inner piece 602 connects to a continuous ring 1020 which extends around the neck 102. As seen in the drawings, when the cap is screwed down onto the neck, as it approaches its final position the inner annulus is stretched around and snaps past the retaining ring 1020. It then acts as a one-way barb preventing the cap from rising back up the neck, and thereby preventing it from coming undone. For the cap to be unscrewed, a user must exert sufficient force (by forceful unscrewing of the cap) to break the links 605.

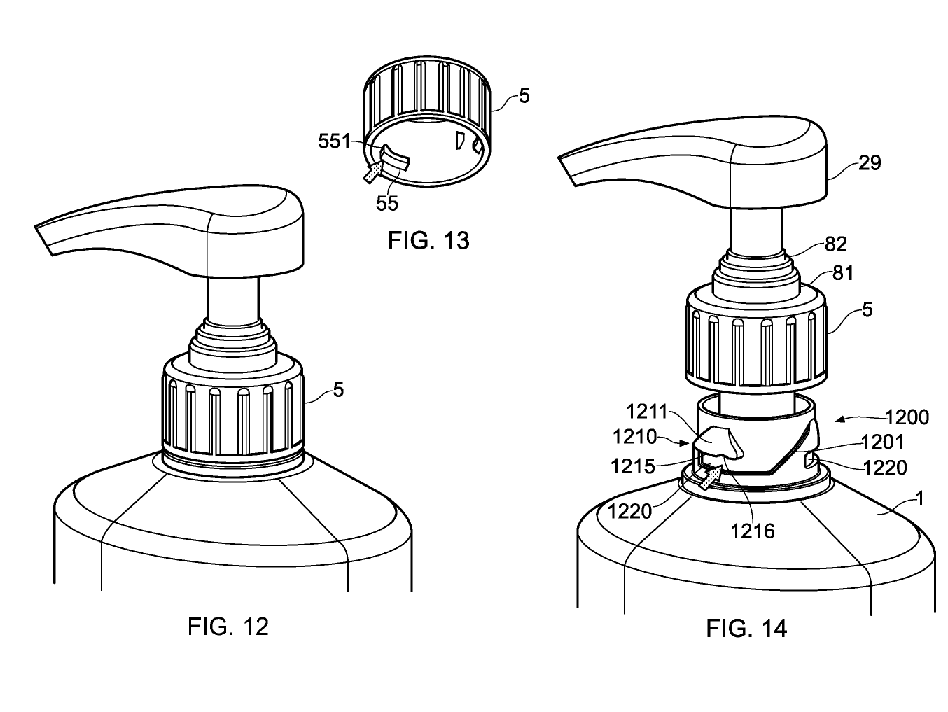

A fourth exemplary embodiment of the present invention is shown in FIGS. 12 to 14. FIG. 12 shows the dispenser with the closure cap in a locked position. FIG. 13 is a perspective view of the inside of the cap 5. FIG. 14 shows the dispenser in an unlocked and unscrewed position with the cap 5 shown in an elevated position.

In this embodiment the closure and locking mechanism comprises two or three lugs 55 attached to the cap 5 and projecting inwardly. These lugs 55 have a contoured surface. There is a protrusion 551 at the top of the lug 55, at one end. This protrusion 551 is for locking engagement in a corresponding concavity or notch 1216 on the lug 1210 on the neck 1200. In this example, the neck 1200 has thread-like features 1201—generally helical respective guide ramps for the cap lugs—with a relatively steep gradient for the cap 5 to be twisted onto the neck 1200. The lug 55 also has an end without a protrusion 551. This end is shaped to fit into the available space 1220 in the thread or neck formation (FIG. 14). This space 1220 is a track vertically confined between the upper side of a horizontal final portion of the guide ramp 1201—it also has an end stop—and the downward face of the lug 1210 having the notch 1216. The track closely fits the cap lug 55 so that the protrusion or detent 551 at the trailing end of the lug clicks firmly into the notch 1216 at the end of tightening down the cap to inhibit release. Of course, other locking lug shapes may be used.

Advantageously, as shown in FIG. 13, the lug 55 on the cap 5 is sloped (decreases in thickness) towards the bottom (see arrow on FIG. 13). This slope provides a ramp. As shown in FIG. 14, the lug 1210 on the neck 1200 increases in thickness from the top to the bottom (the bottom having the contouring or notch 1216). This sloping or ramping 1211 of the corresponding parts of the cap and neck lugs 55,1210 allows the cap to be slotted easily onto the neck 1200 i.e. the lugs 55,1210 slide over each other. The closure is thus designed to be snap-and-twist on and twist off, in the fashion of a bayonet fitting. In other examples, the lugs 55,1210 need not be sloped.

1. A pump dispenser comprising:
a container having a neck, and a pump attached to the container for dispensing fluid to be contained in the container in use;
a closure cap by which the pump is attached to the container neck with a body of the pump inside the container neck;
a securing mechanism comprising respective interengaging securing formations of the closure cap and neck which are operable by relative rotation of the cap and neck to attach and connect the cap fixedly to the neck at a final secured position; and
a catch mechanism engageable between the cap and neck selectively in the final secured position to inhibit rotation of the cap relative to the neck away from the final secured position of the securing mechanism.

2. The pump dispenser of claim 1 wherein the securing mechanism is or comprises a screw thread mechanism with respective thread formations on the cap and neck.

3. The pump dispenser of claim 1 wherein the engagement of the catch mechanism between the cap and neck is towards the container side of the securing mechanism.

4. The pump dispenser of claim 1 wherein the catch mechanism comprises respective detent formations on each of the cap and neck which come into engagement at the final secured position thereof.

5. The pump dispenser of claim 4 wherein the cap and/or the neck has one or more circumferentially localized detent formations which come into engagement for a snap, at the final secured position.

6. The pump dispenser of claim 5 wherein the cap and/or the neck has plural circumferentially-spaced detent formations.

7. The pump dispenser of claim 6 wherein one of said detent formation of the catch mechanism on one of the cap and neck has an abrupt abutment side or face, to retain a corresponding detent formation on the other of the cap and neck against movement away from the final closed position, such as rotational movement, in the engaged position, and an oppositely-directed ramp, sloping or compliant side or face to allow said corresponding detent formation on the other of the cap and neck to ride past to reach the engaged position.

8. The pump dispenser of claim 7 wherein the abutment side or face is circumferentially directed relative to the neck, to inhibit relative rotation of neck and cap directly.

9. The pump dispenser of claim 7 wherein the abutment side or face is axially directed relative to the neck, to inhibit rotation indirectly by blocking axial movement of the cap off the neck.

10. The pump dispenser of claim 1 wherein the catch mechanism is releasable by a release action.

11. The pump dispenser of claim 10 wherein the cap comprises a deflectable portion carrying a detent formation of the catch mechanism, and predetermined deflection of said portion disengages the detent formation from a corresponding detent formation of the neck to allow movement of the cap and neck away from the final secured position.

12. The pump dispenser of claim 11 wherein the cap comprises plural said deflectable portions with respective detent formations, whereby the release action requires simultaneous deflection of the plural portions.

13. The pump dispenser of claim 11 wherein the cap comprises an attached collar, preferably at the container end of the cap, and the deflectable portion(s) is/are comprised in said collar or in respective collar portions.

14. The pump dispenser of claim 10 wherein the cap comprises a break-off portion connected to the cap by one or more frangible links and comprising a detent formation of the catch mechanism, whereby the release action comprises forcible detachment of said portion to undo the catch mechanism and allow movement of the cap and neck away from the final secured position.
